(19) United States
(12) Patent Application Publication
(10) Pub. No.: US 2020/0039641 A1
(43) Pub. Date: Feb. 6, 2020

(54) ABRASION STRIP AND METHOD OF MANUFACTURING THE SAME

(71) Applicant: Bell Helicopter Textron Inc., Fort Worth, TX (US)

(72) Inventors: Andrew Paul Haldeman, Fort Worth, TX (US); Dalton T. Hampton, Fort Worth, TX (US); Aaron Alexander Acee, Flower Mound, TX (US); James Adrain Cordell, Azle, TX (US)

(73) Assignee: Bell Helicopter Textron Inc., Fort Worth, TX (US)

(21) Appl. No.: 16/053,611

(22) Filed: Aug. 2, 2018

(51) Int. Cl. B64C 27/473; B64C 29/00; B21D 22/02; B21D 53/92

(52) U.S. Cl. CPC B64C 27/473; B64C 29/0033; C22F 1/00; B21D 53/92; B21D 22/022

(57) ABSTRACT

An abrasion strip and method of manufacturing the same. The abrasion strip being composed of INCONEL® alloy 718SPF™ and being shaped by superplastic forming.

### BACKGROUND

Abrasions strips are attached to the leading edges of rotor blades to protect the rotor blades from being damaged by high-speed impact of airborne debris and/or water. Most conventional abrasion strips are composed of a stainless-steel base layer with a nickel cap attached thereto. The stainless steel base layer is formed by bending and/or stretching a sheet of stainless steel over a die. Then, a nickel cap is either electroplated directly onto the formed stainless steel base layer, or the nickel cap is created via electroless nickel plating and the nickel plate is then bonded or mechanically fastened to the stainless steel base layer.

However, stainless steel has a minimum bend radius that is larger than what is often preferred for aerodynamically optimal rotor blade design, particularly toward the rotor blade tip as the radius of the leading edge tapers down. In addition, nickel electroplating and electroless nickel plating is a very expensive and extremely complicated, particularly when forming complex shapes. As such, abrasion strips that have complex profiles along the span of the rotor blades are usually formed in several parts that are then separately attached.

Precision repeatability is also difficult to achieve with nickel plating. Given the immense importance to the aerodynamic performance and balance of the rotor blades, it is imperative that all the abrasions strips match each other as closely as possible. Therefore, a large amount of time is spent manually abrading and/or chemically stripping excess material from the nickel caps in order to achieve the desired profile. Moreover, as rotor blade design continues to evolve, more complex leading edge shapes are being utilized, exacerbating the difficulty in forming the required abrasion strips.

### BRIEF DESCRIPTION OF THE DRAWINGS

FIG. 1 is an oblique view of an aircraft according to this disclosure.

FIG. 2 is an oblique view of the rotor of the aircraft of FIG. 1.

FIG. 3 is an oblique view of a rotor blade having a complex leading edge.

FIG. 4 is a cross-sectional view of the rotor blade of FIG. 3.

FIG. 5 is a cross-sectional top view of a die for superplastically forming an abrasion strip.

FIG. 6 is a cross-sectional side view of the die of FIG. 5.

### DETAILED DESCRIPTION

In this disclosure, reference may be made to the spatial relationships between various components and to the spatial orientation of various aspects of components as the devices are depicted in the attached drawings. However, as will be recognized by those skilled in the art after a complete reading of this disclosure, the devices, members, apparatuses, etc. described herein may be positioned in any desired orientation. Thus, the use of terms such as “above,” “below,” “upper,” “lower,” or other like terms to describe a spatial relationship between various components or to describe the spatial orientation of aspects of such components should be understood to describe a relative relationship between the components or a spatial orientation of aspects of such components, respectively, as the device described herein may be oriented in any desired direction. In addition, the use of the term “coupled” throughout this disclosure may mean directly or indirectly connected, moreover, “coupled” may also mean permanently or removably connected, unless otherwise stated.

This disclosure divulges abrasion strips formed of INCONEL® alloy 718SPF™ and a method of manufacturing the same. INCONEL alloy 718SPF™ was developed to meet the need for an alloy suitable for manufacture into components subject to a combination of high temperature, high-temperature corrosion, and high stress. INCONEL® alloy 718SPF™ has excellent creep-rupture strength at temperatures up to 1300 degrees Fahrenheit (700 degrees Celsius). As such, INCONEL® alloy 718SPF™ is used for the manufacture of components in gas turbines, rocket engines, nuclear reactors, and spacecraft. Helicopter rotor blades are never subject to the conditions INCONEL alloy 718SPF™ was designed for. In addition, INCONEL® alloy 718SPF™ has inferior abrasion resistance when compared to a 100 percent nickel or an 85+percent nickel-phosphorous alloy, as produced from electroplating or electroless plating, respectively. However, because INCONEL® alloy 718SPF™ does include 50 to 55 percent nickel and 17 to 21 percent chromium, it has fairly robust abrasion resistance. It also has the ability to be superplastically formed into complex shapes, in an accurate and repeatable manner. Therefore, even though abrasion strips formed of INCONEL® alloy 718SPF™ may have inferior wear properties compared to the nickel-capped abrasion strips currently used, the time/labor savings afforded by manufacturing complexly shaped abrasion strips by superplastic forming can outweigh the relatively shorter service life of the INCONEL® alloy 718SPF™ abrasion strips disclosed herein. The composition and physical properties of INCONEL® alloy 718SPF™ are described in Special Metals Corporation's Publication Number SMC-096, September 2004, which is incorporated by reference herein in its entirety.

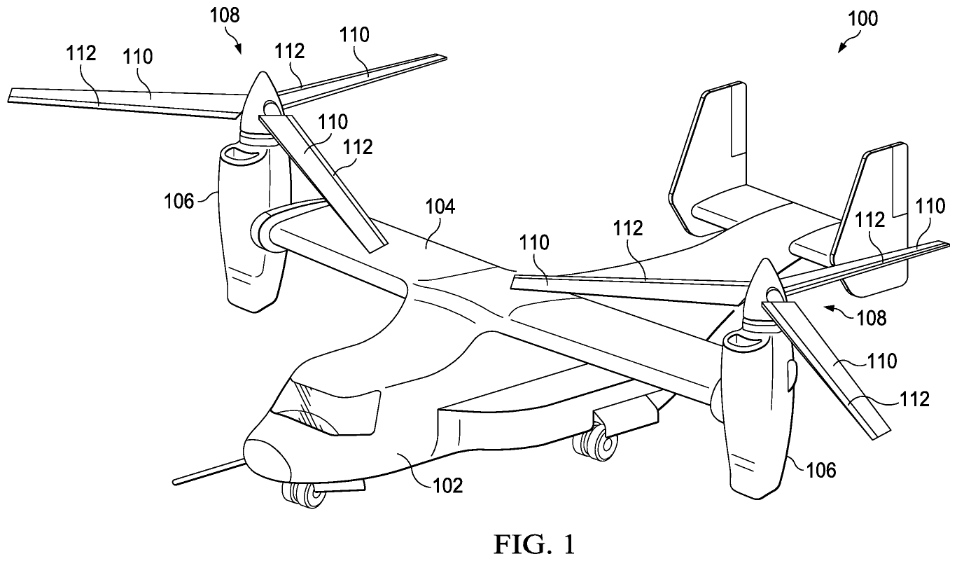

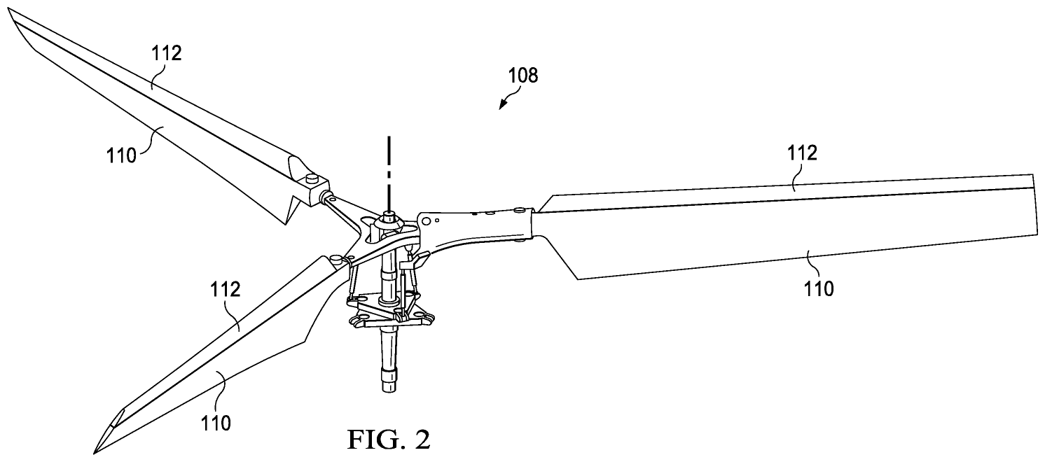

Referring to FIG. 1, a tiltrotor aircraft 100 is illustrated. Tiltrotor aircraft 100 includes a fuselage 102, a wing 104, a pair of rotatable nacelles 106, and a pair of rotatable proprotors 108. Each rotatable proprotor 108 has a plurality of rotor blades 110. Removably coupled to each rotor blade 110 is an abrasion strip 112 superplastically formed of INCONEL® alloy 718SPF™. The position of rotatable proprotors 108, as well as the pitch of rotor blades 110, can be selectively controlled to control direction, thrust, and lift of tiltrotor aircraft 100. FIG. 1 illustrates tiltrotor aircraft 100 in a helicopter mode, in which rotatable proprotors 108 are positioned substantially vertical to provide a lifting thrust. In an airplane mode (not shown) rotatable proprotors 108 are positioned substantially horizontal to provide a forward thrust in which a lifting force is supplied by wing 104. It should be appreciated that tiltrotor aircraft 100 can be operated such that rotatable proprotors 108 are selectively positioned between airplane mode and helicopter mode, which can be referred to as a conversion mode. FIG. 2 illustrates abrasion strips 112 covering the full length of the leading edges of rotor blades 110.

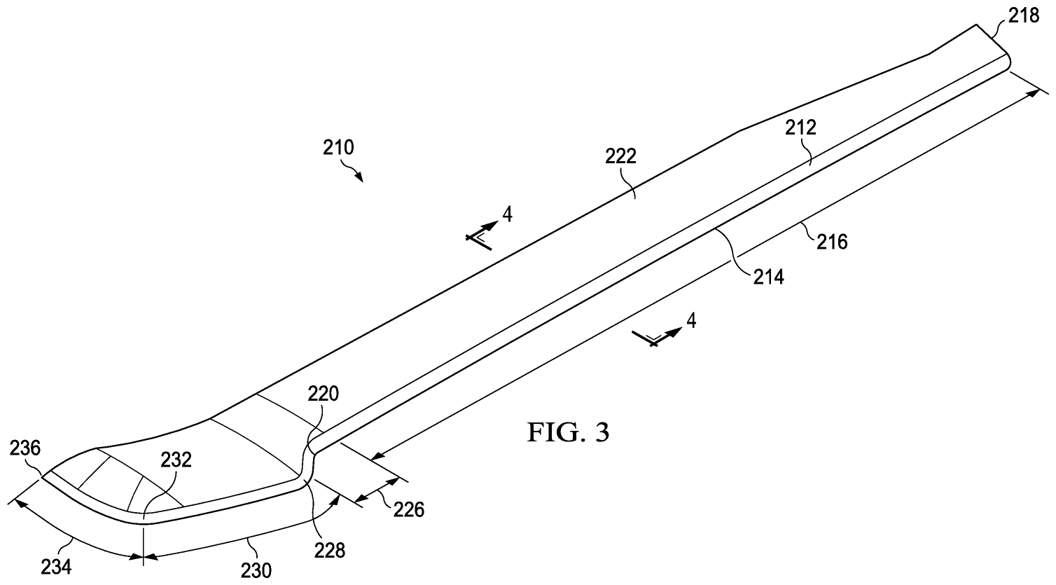

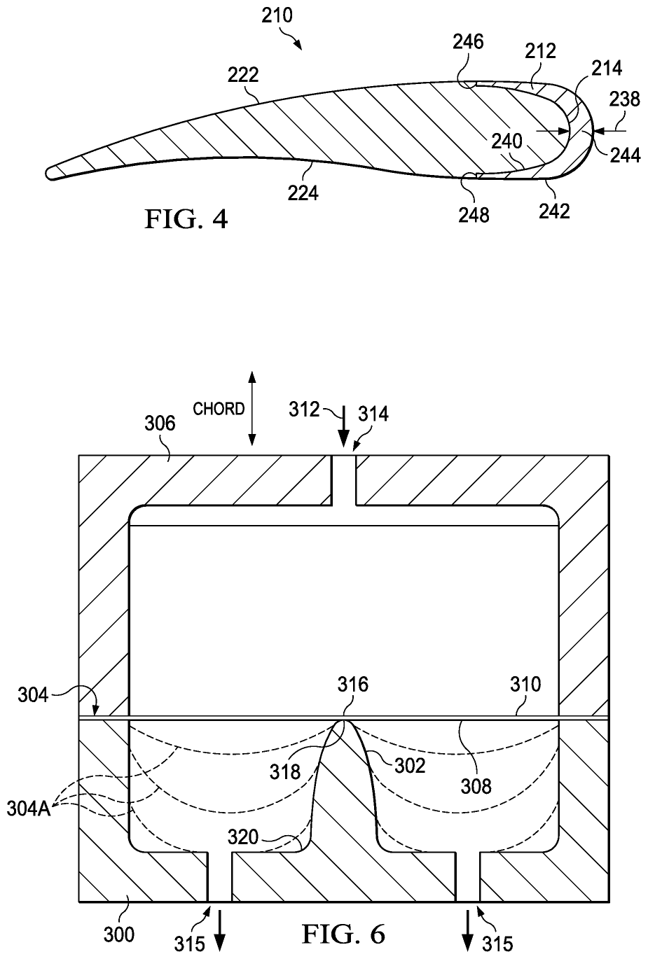

FIGS. 3 and 4 show a rotor blade 210 that has a complex-shaped leading edge 214. Leading edge 214 is protected by an abrasion strip 212 formed as a unitary structure by superplastically forming it from a sheet of INCONEL® alloy 718SPF™. Leading edge 214 has a generally uniform shape along a main section 216. Main section 216 extends from a root end 218 to a notch 220, covering a majority of a span of rotor blade 210. That is, main section 216 of leading edge 214 is straight along the span and maintains the same curvature profile from a top surface 222 to a bottom surface 224. At notch 220, leading edge 214 has a forward swept section 226 that extends forward of main section 216 from notch 220 to a leading point 228. From notch 220 along forward swept section 226 to leading point 228, leading edge 214 has a constantly changing radius of curvature along the span. At leading point 228, leading edge 214 tightly transitions from a forward sweep to a rearward sweep. A backswept section 230 extends from leading point 228 to an anhedral junction 232. Along backswept section 230, leading edge 214 has a gentle curvature along the span thereof. At anhedral junction 232, leading edge 214 tightly transitions from the gradual rearward sweep of backswept section 230 to a sharp rearward sweep. In addition, at anhedral junction 232, leading edge 214 turns down sharply. An anhedral section 234 extends from anhedral junction 232 to a tip 236. Along a length of anhedral section 234, from anhedral junction 232 to tip 236, the curvature profile of leading edge 214, from top surface 222 to bottom surface 224, gradually decreases.

As shown in FIG. 4, abrasion strip 212 has a thickness 238 measured from a first surface 240 to an opposite second surface 242. First surface 240 of abrasion strip 212 is configured to conform to leading edge 214 of rotor blade 210, extending from top surface 222 to bottom surface 224. Second surface 242 is configured to line up flush with top surface 222 and bottom surface 224 and complete an airfoil profile of rotor blade 210. Thickness 238 of abrasion strip 212 varies from a maximum at a middle 244 thereof, and thickness 238 gradually reduces to a minimum at a top end 246 and a bottom end 248. This gradually varying thickness 238 is preferable because middle 244 is subject to the most abrasive forces. The further away from middle 244 the less abrasive forces abrasion strip 212 experiences. Accordingly, less material is required away from middle 244 to achieve the same wear rate. This chordwise reduction in material aids in keeping the chordwise center of gravity within the preferred leading twenty-five percent of the chord length. Moreover, this diminished thickness 238 at top end 246 and bottom end 248 requires a smaller step in the composite layup to provide a smooth transition between second surface 242 and top surface 222 and bottom surface 224. In addition to this chordwise varying of thickness 238, thickness 238 may vary spanwise as well. As the velocity of rotor blade 210 increases towards tip 236, so too increases the impact speed with debris, and therefore, the abrasive forces are greater toward tip 236. Therefore, it may be desirable for thickness 238 to increase along the span from root end 218 to tip 236.

Given the complexity of leading edge 214, it would be nearly impossible to fabricate a unitary abrasion strip for rotor blade 210 utilizing conventional methods. As described in further detail below, this tapering of material from middle 244 to top end 246 and bottom end 248, as well as tapering from tip 236 to root end 218, results from what is often considered an undesirable side effect of superplastic forming. That is, the further the material is stretched from its original form, the thinner the material becomes. When creating an abrasion strip by superplastic forming, that normally undesirable side effect leads to a desirably contoured cross-sectional profile.

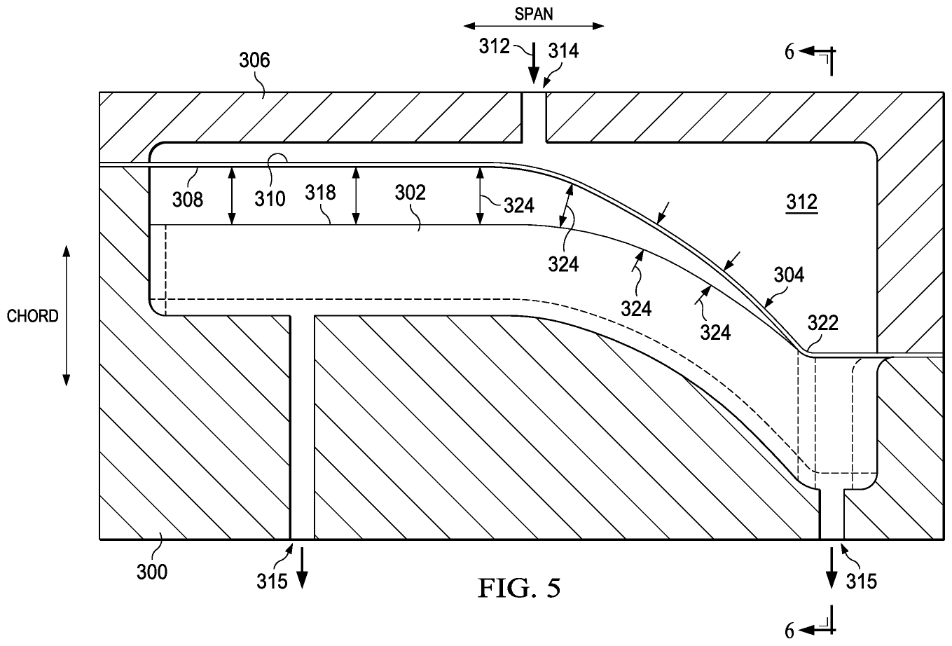

Referring to FIGS. 5 and 6, the process of superplastically forming an abrasion strip from INCONEL® alloy 718SPF™ is illustrated. A lower forming die 300 includes a profile 302 matching a leading edge of a rotor blade. A sheet of INCONEL® alloy 718SPF™ 304 is clamped between lower forming die 300 and an upper forming die 306. Sheet 304 includes a first surface 308 facing lower forming die 300 and a second surface 310 facing upper forming die 306. Sheet 304 is heated in an environment with a temperature of at least 1700 degrees Fahrenheit (926.7 degrees Celsius), preferably about 1750 degrees Fahrenheit (954.4 degrees Celsius). Then, a pressurized inert gas 312 is introduced through an inlet 314 in upper forming die 306. Inert gas 312 fills the space between second surface 310 of sheet 304 and upper forming die 306 and is pressurized to at least 250 psi (1.72 Mpa), preferably about 300 psi (2.07 Mpa). The force applied by pressurized inert gas 312 against second surface 310 of heated sheet 304 causes sheet 304 to stretch towards lower forming die 300. As sheet 304 stretches towards lower forming die 300, the air at atmospheric pressure between first surface 308 and lower forming die 300 is pushed out through outlet vents 315. Prior to stretching, sheet 304 had a uniform thickness measured between first surface 308 and second surface 310. However, as sheet 304 stretches towards lower forming die 300, the thickness of sheet 304 decreases until first surface 308 contacts lower forming die 300. For example, FIG. 6 shows the deflection of sheet 304 over time as dashed lines 304A. Because a center 316 of sheet 304 contacts an apex 318 of profile 302, center 316 will have the greatest thickness, while portions of sheet 304 that stretch all the way to a base 320 of profile 302, having stretched the farthest, will be the thinnest. Therefore, the method shown in FIG. 6 will produce a cross-section similar to that of abrasion strip 212 shown in FIG. 4.

In addition to producing the chordwise thickness variation formed by the orientation shown in FIG. 6, FIG. 5 shows an orientation for producing a spanwise thickness variation. In FIG. 5, sheet 304 is pre-shaped by bending sheet 304 so that at tip end 322 is in contact with apex 318 immediately, and therefore, the thickness of the finished product at tip end 322 will be unchanged from pre-formed sheet 304, because it doesn't stretch before contacting lower forming die 300. However, a gap 324 between first surface 308 and apex 318 varies spanwise. As such, the further from tip end 322, the further sheet 304 stretches before first surface 308 contacts apex 318, and therefore, the formed abrasion strip will be thinner away from tip end 322.

Sheet 304 may be pre-shaped in any variety of ways to aid in achieving the final desired shape, including by cutting, bending, and even welding additional sheets of INCONEL® alloy 718SPF™ to sheet 304. In addition, INCONEL® alloy 718SPF™ may be heat treated to further increase the durability of the formed abrasion strip.

While this disclosure shows and discusses rotor blade abrasion strips superplastically formed of INCONEL® alloy 718SPF™ for use with tiltrotor aircraft 100, it should be understood that the abrasion strips, and methods for manufacturing the same, disclosed herein may be used for any rotary blades that may benefit from utilizing abrasions strips.

At least one embodiment is disclosed, and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 95 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention. Also, the phrases “at least one of A, B, and C” and “A and/or B and/or C” should each be interpreted to include only A, only B, only C, or any combination of A, B, and C.

What is claimed is:

1. An abrasion strip, comprising:
a first surface configured to conform to a leading edge of a rotor blade, the first surface being configured to extend from a top surface of the rotor blade to a bottom surface of the rotor blade; and
a second surface opposite the first surface, wherein the second surface is configured to complete an airfoil profile of the rotor blade;
wherein the first surface and the second surface converge at a top end and at a bottom end;
wherein the abrasion strip is formed of INCONEL® alloy 718SPF™.

2. The abrasion strip of claim 1, wherein a thickness of the abrasion strip measured between the first surface and the second surface varies in a chordwise direction.

3. The abrasion strip of claim 2, wherein a curvature of the first surface extending from the top end to the bottom end is different in at least two locations along a length of the abrasion strip.

4. The abrasion strip of claim 2, wherein a spanwise curvature of the second surface is different in at least two locations along a length of the abrasion strip.

5. The abrasion strip of claim 2, wherein the thickness of the abrasion strip varies in a spanwise direction.

6. The abrasion strip of claim 2, further comprising:
a first section configured to extend along a majority of a length of the leading edge of the rotor blade; and
a backswept section configured to cover a backswept portion of the leading edge of the rotor blade;
wherein the first section and the backswept section comprise a unitary structure.

7. The abrasion strip of claim 6, further comprising:
a forward swept section configured to cover a forward swept portion of the leading edge of the rotor blade;
wherein the forward swept section is integral with the unitary structure.

8. The abrasion strip of claim 7, further comprising:
an anhedral section configured to cover an anhedral portion of the leading edge of the rotor blade;
wherein the anhedral section is integral with the unitary structure.

9. An aircraft, comprising:
a fuselage;
a rotor blade having a leading edge, a top surface, and a bottom surface; and
an abrasion strip, comprising:
a first surface configured to conform to the leading edge of the rotor blade, the first surface being configured to extend from the top surface of the rotor blade to the bottom surface of the rotor blade; and
a second surface opposite the first surface, wherein the second surface is configured to complete an airfoil profile of the rotor blade;
wherein the first surface and the second surface converge at a top end and at a bottom end;
wherein the abrasion strip is formed of INCONEL® alloy 718SPF™.

10. The aircraft of claim 9, wherein a thickness of the abrasion strip measured between the first surface and the second surface varies in a chordwise direction.

11. The aircraft of claim 10, wherein a curvature of the first surface extending from the top end to the bottom end is different in at least two locations along a length of the abrasion strip.

12. The aircraft of claim 11, wherein a spanwise curvature of the second surface is different in at least two spots along the length of the abrasion strip.

13. The aircraft of claim 12, wherein the thickness of the abrasion strip varies in a spanwise direction.

14. The aircraft of claim 13, wherein the abrasion strip is a unitary structure.

15. A method for fabricating an abrasion strip, comprising:
providing a die shaped as a leading edge of a rotor blade;
providing a sheet of INCONEL® alloy 718SPF™, the sheet having a first surface facing the die and an opposite second surface;
heating the sheet in an environment of at least 1700 degrees Fahrenheit (926.7 degrees Celsius); and
applying an inert gas with a pressure of at least 250 psi (1.72 Mpa) to the second surface of the sheet.

16. The method of claim 15, further comprising:
pre-shaping the sheet before the heating and applying the inert gas.

17. The method of claim 15, wherein the pre-shaping comprises:
bending the sheet to approximate a forward swept and/or a rearward swept section.

18. The method of claim 15, wherein the pre-shaping further comprises:
welding a second sheet to the sheet.

19. The method of claim 15, further comprising:
heat treating the abrasion strip.

20. The method of claim 15, wherein a thickness of the sheet measured from the first surface to the second surface is uniform before the applying the inert gas and varies after the applying the inert gas.
